(19) United States
(12) Patent Application Publication
(10) Pub. No.: US 2025/0250927 A1
(43) Pub. Date: Aug. 7, 2025

(54) Heat Engine

(71) Applicant: Jack Samuel Nihill, Greensborough (AU)

(72) Inventor: Jack Samuel Nihill, Greensborough (AU)

(21) Appl. No.: 18/855,030

(22) PCT Filed: Jan. 22, 2023
(86) PCT No.: PCT/AU2023/050035

§ 371 Date: Jul. 27, 2023

(30) Foreign Application Priority Data
Jan. 22, 2022 (AU) 2022900123

(51) Int. Cl. F02C 1/10; F01K 7/12; F01K 11/00; F04D 29/22

(52) U.S. Cl. CPC F02C 1/105; F01K 7/12; F01K 11/00; F04D 29/2255; F05D 2240/24; F05D 2250/25; F05D 2260/20

(57) ABSTRACT

The present invention provides a heat engine operating on a novel closed thermodynamic cycle. The primary characteristics of the heat engine comprise a boiler, condenser, liquid pump, and a regenerative expander in which heat is recovered from the expansion/work extraction process to be returned to the sensible heat addition process that occurs between the condenser outlet and the boiler inlet. The regenerative expander may be comprised of a novel turbine design described as part of the present invention. The primary characteristic of the turbine being a rotor consisting of a hub intersected by a plurality of narrow helical channels through which motive fluid is directed by a plurality of nozzles to induce rotation in the same direction as the helical path of the channels. The liquid pump of the heat engine may also be comprised of a novel design based on similar working principles to the above turbine.

### TECHNICAL FIELD

The present invention relates to the field of heat engines. More specifically it relates to closed cycle heat engines and the core component fluid-mechanical energy conversion devices e.g., turbines/expanders etc.

### BACKGROUND

It is accepted that the highest theoretical efficiency obtainable for a heat engine operating between two thermal reservoirs at temperatures TH and TL, having a given difference in temperature (delta T), is one where each of the processes that make up the thermodynamic power cycle is reversible. The most well-known example of such an ideal heat engine is one that operates on the Carnot cycle, the temperature-entropy (T-s) diagram (100) of which is shown in FIG. 1. The Carnot cycle is comprised of four processes as follows: Reversible adiabatic compression (105—work input), reversible isothermal expansion (110—heat addition), reversible adiabatic expansion (115—work output), reversible isothermal compression (120—heat rejection). The net work output of the Carnot cycle is given by the area (125) enclosed by the cycle processes on a T-s diagram (100), and the efficiency of the cycle is the ratio of this area to the total heat input.

In practical applications, fully reversible (isentropic) expanders and compressors are unobtainable. As a result of this and other similar limitations in achieving the other fully reversible processes required to implement a Carnot engine, real heat engines will always operate at thermal efficiencies lower than that which would be achieved by the Carnot cycle (hereafter referred to as Carnot efficiency).

An example of the ways in which practical heat engines depart from the Carnot cycle is shown on a T-s diagram (200) in FIG. 2. The isothermal processes that make up the heat addition (110) and heat rejection (120) components of a Carnot engine can be closely approximated by the phase-change processes undergone by fluids as they are evaporated (205—isothermal expansion) or condensed (210—isothermal compression). A Carnot cycle based on these practical isothermal processes is represented in FIG. 2 (215).

If these two processes are taken as a starting point to construct a practical thermodynamic power cycle, the greatest departure from the Carnot cycle becomes the work input process. Compressing saturated mixtures of liquid and vapour poses significant practical challenges, even before considering the need for the process to be close to isentropic if the Carnot cycle is to be emulated. Therefore, in practical thermodynamic power cycles, additional heat is removed during the isothermal compression process (210) in order to take the working fluid to a fully liquid state (220). This has the beneficial effect of greatly simplifying and reducing the work input required to compress the working fluid to the cycles maximum pressure (225). However, it also introduces a requirement for additional sensible (non-isothermal) heating (230) in order to bring the high-pressure liquid working fluid up to the temperature of the isothermal expansion (evaporation) process (205).

This combination of reduced work input (225) combined with additional heat input (230) will always be less efficient than the equivalent isentropic process (235). Further, while practical turbines may achieve near adiabatic expansion, they are not 100% isentropic, hence additional departures from the Carnot cycle are introduced during the work output process (240) as well. The areas 245 and 250 in FIG. 2 show how the practical cycle described departs from a Carnot cycle (215) built off the same isothermal expansion process (205).

The net work output of the practical cycle is given by the total area (215+245+250) enclosed by the processes of the cycle. This is greater than the net work output of Carnot cycle described by 215. However, in order to see how these departures affect the efficiency of the practical cycle, a comparison needs to be made with a Carnot cycle of equivalent net work output. Such a cycle cannot be reasonably represented in the context of a real working fluid operating across liquid, saturated mixture and vapour states, hence the practical T-s diagram from FIG. 2 is transferred to the T-s diagram (300) in FIG. 3 without the saturation line (255) to indicate where changes in working fluid state occur, thereby abstracting the cycle to a generic case in order to allow the required comparison.

In FIG. 3, with the area enclosed by the Carnot cycle (305) expanded to be equivalent to that enclosed by the practical cycle from FIG. 2 (310), without changing the delta T, it is clear that there is significant additional heat input required for the practical cycle (315) in order to achieve the same net work output, and hence the efficiency of the practical cycle will be correspondingly lower than the Carnot efficiency for the given delta T.

The practical cycle shown in FIG. 2, which is based on the Rankine cycle, assumes that a mixed phase capable turbine is used as the expander (i.e., one that can handle fluid in the saturated mixture state). In practice, this also poses several challenges which historically have resulted in even greater departures from the Carnot cycle being accepted as trade-offs for reliability, longevity etc. However, as the present invention also relies on mixed phase expansion, these additional departures from the Carnot cycle will not be discussed further here as they do not serve as useful background.

It can be surmised that if some of the thermal energy in a practical heat engine such as the one described by the cycle in FIG. 2 could be reclaimed from the work output process (240) and re-introduced to the system during the sensible heat input process (230), the efficiency of the system can be brought closer to the Carnot efficiency. Continuing along this path of reasoning results in the idealised version of the thermodynamic cycle that underpins this invention as follows:

First, in order to achieve similar thermal efficiency to that which would be achieved by an equivalent Carnot engine, both the net work output and the required heat input must be in the same ratio as they are in the Carnot cycle (as thermal efficiency is equal to the net work output divided by the heat input).

Second, if the area enclosed by a practical thermodynamic cycle on a T-s diagram can be made equal to an equivalent Carnot cycle, the net work outputs will be equal.

Third, if it is accepted that, for a practical thermodynamic cycle built around isothermal phase change processes, an equivalent Carnot cycle can be constructed such that the evaporation process is taken as the isothermal expansion process for the Carnot cycle, and the rest of the cycle is completed from there. It follows that in order to approach equal heat inputs, the practical cycle must limit any additional heat input that is not required for the evaporation process.

Finally, if it is assumed that the same modification to the ideal isentropic compression process that is used by most other practical phase-change based thermodynamic power cycles is implemented (namely condensation to saturated liquid followed by liquid compression then sensible heating), then in order to maintain equal net work output to the equivalent Carnot cycle, the expansion process must necessarily follow a near parallel path to the sensible heating process. This path would necessitate a reduction in entropy across the expansion process which would only be possible if heat is extracted as well as work (even an ideal adiabatic expander would only result in entropy remaining constant). Extracting heat during this process would however serve no practical purpose unless that heat can be returned to the cycle and therefore reduce the net heat input required.

The T-s diagram (400) shown in FIG. 4 represents the ideal thermodynamic power cycle arrived at after following the above logical steps and is the theoretical basis of the present invention. This cycle will be referred to here as the regenerative expansion cycle. For idealised heat exchange processes, the sensible heat input in process 415 would approach zero, and thus the net heat input would approach that of the equivalent Carnot cycle (420). Further, as the ideal regenerative expansion cycle closely approximates a parallelogram on the T-s diagram (400) with the same area as the equivalent (rectangular) Carnot cycle (420), the thermal efficiency of the regenerative expansion cycle would therefore approach the Carnot efficiency for the given delta T between the driving thermal reservoirs.

The key characteristic of the ideal regenerative expansion cycle that underpins the novelty of this invention is that the net work output process (405) should be made to run, in the ideal case, near parallel to the slope formed by the sensible heating processes 410 and 415. Where this is attempted with actual concurrent expansion and heat extraction however, the resulting process is unable to approximate this ideal process well over a wide range of temperature differences, being limited in effectiveness to low temperature difference applications.

Noting the requirement of the regenerative expansion cycle for mixed phase fluid expansion, one type of turbine which has shown particular promise in this regard is the boundary layer turbine invented by Nikola Tesla in 1913. In his 1913 patent (serial no. 603,049), Nikola Tesla described a turbine operating on the principle of “skin resistance” between a fluid and a solid body. The turbine, in brief terms, consists of several narrowly spaced discs arranged on a shaft (so as to form a rotor) in order to convert the power in a moving fluid to mechanical rotation. Fluid is directed between the discs via a number of nozzles such that it enters the rotor at the outer edge in a generally tangential manner, where, upon entering the space between the discs, it transmits some of its kinetic energy to the rotor, dragging it along in the direction of the fluids motion. As energy is extracted from the fluid, it necessarily decelerates, causing it to spiral inwards towards the axis of rotation where eventually it is permitted to leave the rotor via several slots, or holes, near the centre of the discs.

Tesla described one of the key advantages of such a method of power conversion as being the ability for the motive fluid to follow “natural paths or streamlines of least resistance” and “to change its velocity and direction of movement by imperceptible degrees, thus avoiding the losses due to sudden variations while the fluid is imparting energy”.

One aspect of Tesla's design that does not follow this principle of causing the motive fluid to follow the path of least resistance however is the exit pathway. Here fluid from between each pair of discs transitions 90° from a radial inwardly spiralling flow path to an axial flow path where it is also joined by the fluid from each of the other inter-disc spaces. It is recognised here that this aspect of the above design necessarily limits the number of discs that can be utilised before losses at this transition region become too great, and that this consequently limits the potential to increase the surface area of the turbine in contact with the fluid (e.g., by adding more discs) in order to increase the power that is extracted from the fluid.

There have been many variations on Tesla's design, however, most depart only slightly from the original. For example, by including features such as aerofoil shaped guide vanes as spacers between the discs (rather than the original circular ones) or making housing modifications to suit specific applications, such as in vertical axis boundary layer wind turbines (see e.g., AU2007356409C1). Further, alternative turbine designs based on the use of “skin resistance” (alternatively referred to as the boundary layer effect, Prandtl layer effect etc.) have been proposed that do not use the “stacked disc” style of rotor (see e.g., AU2016291301B2, which describes the use of nested tubes rather than stacked discs to transmit kinetic energy from a motive fluid to a rotor).

In a 2021 paper, Talluri et. al. present a modified Tesla turbine, specifically designed for 2-phase fluid expansion (mixed liquid and vapour flow). One of the key modifications made was the inclusion of a rotating diffuser as the hub for the rotor discs, in order to minimise losses during the transition from radial to axial flow. However, while the flow characteristics were improved by this design, the number of discs that could practically be included in the rotor is still limited to a relatively small number due to the physical requirements of the diffuser shape.

### SUMMARY OF INVENTION

The object of the present invention is to affect an improved, alternative mechanism for converting a difference in temperature to useful work via a thermodynamic power cycle referred to here as the regenerative expansion cycle. Moreover, it is an object of the present invention to closely approximate the ideal case of this cycle across a wide range of driving temperature differences.

In an embodiment, the invention provides, a heat engine comprising:
(i) A boiler in which heat is added to a working fluid to facilitate an isothermal expansion process.
(ii) A condenser in which heat is removed from the same working fluid to facilitate an isothermal compression process.
(iii) A liquid pump, or series of pumps, connected between the condenser outlet and the boiler inlet which increases the pressure of the liquid working fluid exiting the condenser until it reaches a pressure at which it can enter the boiler.
(iv) A regenerative expander connected between the boiler outlet and the condenser inlet which comprises: (a) A mechanism for multi-staged, alternate heat and work extraction from the working fluid as it expands from the pressure at the outlet of the boiler to the pressure at the inlet to the condenser such that the net process described approximates the ideal expansion process for a regenerative expansion cycle. (b) A mechanism for transferring the heat extracted during the regenerative expansion process to the liquid working fluid as it is moved from the exit of the condenser to the inlet of the boiler. In an embodiment, the regenerative expander may be comprised of a novel boundary layer turbine Incorporating a vapour to liquid heat exchanger (described in more detail below).

The objective of the novel boundary layer pump and turbine referenced above (iii and iv) is to affect an alternative method of harnessing the wall shear stress (or boundary layer effect) in combination with subtle redirection of fluid by minute degrees as a means of energy transfer between a fluid and rotor.

The principle of operation of these devices will be described primarily from the context of using fluid as a motive agent to drive the rotor in order to extract power from the fluid (i.e., a turbine). It will be understood however that these principles will also have application in the compression or propulsion of fluid (i.e., a pump).

The principle on which these novel boundary layer devices are built is similar to that described by Tesla. Specifically, to utilise the boundary layer effect in order to transfer energy from a moving fluid to a rotor (or vice versa), and to cause the fluid to follow streamlines of least resistance in order to minimise losses due to sudden changes in velocity.

In contrast to Tesla's boundary layer turbine however, rather than utilise multiple radially planar flow paths (i.e., flat spiral flow paths), constructed from parallel discs, which then transition to axial flow at the exit (along the centre of the rotor), the present invention causes the motive fluid to follow a helical flow path along the axis of rotation of the rotor, thereby eliminating any sudden transitions in velocity at either the inlet or exit of the turbine. By extending the planar spiral flow path of Tesla's turbine into a three-dimensional helical path, not only is the transition from purely radial to purely axial flow eliminated, but the entire length of each fluid channel can be maintained close to the outer boundary of the rotor. This opens up the possibility for simple methods of controlling heat transfer rates during the mechanical energy transfer process.

Specifically, an embodiment of the novel boundary layer turbine is a rotary turbine in which the rotor comprises a shaft with a hub which is intersected by a plurality of narrow channels through which the motive fluid is directed by a number of nozzles arranged around the inlet of the turbine. Further these channels follow a helical path around the axis of rotation of the rotor with the direction of the helix aligned with the direction of rotation when viewed from the fluid inlet. The pitch of the helical channels may be constant, or it may vary along the length of the rotor. Further, the exit of the helical channels may be aligned with the helical path, or it may be redirected to adjust the angle of the fluid exiting the rotor. The depth of the channels and the outer diameter of the rotor may be constant or may vary along the length of the rotor to allow for change in volume of the motive fluid (e.g., vapour expansion due to a drop in pressure). The casing of the turbine and/or the rotor may include features to enable heat transfer to be controlled along the length of the rotor.

It will be appreciated that despite some physical similarities in appearance, the principles in use by the turbine describe above are distinct from those employed by ‘Archimedes screw’ type turbines which utilise fluid pressure acting on one half (or less) of a helical vane in order to induce rotation around the axis of said vane. The physical phenomena employed by such devices result in a rotational direction in opposition to the direction of the helix, and they do not utilise the boundary layer effect in order to induce this rotation.

### DESCRIPTION OF DRAWINGS

Embodiments of the present invention are described, by way of example only, with reference to the accompanying drawings in which:

FIG. 1 is a temperature-entropy (T-s) diagram (100) of the Carnot cycle for an arbitrary working fluid.

FIG. 2 is a T-s diagram (200) of a practical thermodynamic power cycle for an arbitrary working fluid in which phase change processes are utilised to emulate the ideal isothermal processes employed for heat addition and rejection in the Carnot cycle. A Carnot cycle built around the same isothermal expansion process (205) is included for comparison.

FIG. 3 is a T-s diagram (300) of the same thermodynamic power cycle shown in FIG. 2, however any reference to the state of the working fluid is ignored (the saturation curve (255) is removed). A Carnot cycle of equivalent net work output (305) is overlayed onto the same axis, between the same heat source and sink temperatures.

FIG. 4 is a theoretical T-s diagram (400) of the novel regenerative expansion cycle on which the present invention is built. An equivalent Carnot cycle (420) is included for comparison.

FIG. 5 is a schematic representation of a regenerative expansion cycle heat engine, of which the present invention is an improved implementation.

FIG. 6 is a schematic representation of an embodiment of the present invention in which the regenerative expander is constructed from a series of four discrete turbines interspersed with three discrete heat recovery units.

FIG. 7 is a schematic representation of an embodiment of the present invention in which the regenerative expander comprises a single pressure compounded turbine with four expansion stages and three heat recovery stages.

FIG. 8 is a T-s diagram (500) showing the thermodynamic cycle that would be observed for the embodiments described in FIG. 6 and FIG. 7. The points 1-7 on the T-s diagram correspond to the points labelled the same in FIGS. 6 and 7.

FIG. 9 is a schematic representation of a concurrent regenerative expander in which the heat and work extraction occur as a concurrent process rather than alternating processes and which can be approximated as a pressure compounded turbine where the number of expansion stages (and corresponding heat recovery stages) is increased to the point where the pressure drop either closely approximates or achieves a continuous, rather than stepped, process.

FIG. 10 is a T-s diagram (600) showing the thermodynamic cycle that would be observed for the regenerative expander described in FIG. 9. The points 1-7 on the T-s diagram correspond to the points labelled the same in FIG. 9.

FIG. 11 shows the predicted efficiency as a function of driving temperature difference (delta T) for the preferred embodiments described in FIGS. 6 and 7, using water as the working fluid. The equivalent Carnot efficiency is also shown for comparison.

FIG. 12 is a perspective cutaway drawing of an embodiment of a component of the present invention, namely a novel boundary layer turbine which may be used in an embodiment of the regenerative expander.

FIG. 13 is a perspective drawing of three embodiments of the rotor for the boundary layer turbine of FIG. 12 or FIG. 18.

FIG. 14 is a cross-sectional view of three additional embodiments of the rotor for the boundary layer turbine of FIG. 12 or FIG. 18.

FIG. 15 is a perspective drawing of three embodiments of the rotor and nozzle positioning for the boundary layer turbine of FIGS. 19 to 21.

FIG. 16 is an alternate angle perspective drawing of the same three embodiments of the rotor and nozzle positioning from FIG. 15.

FIG. 17 is a cross-sectional view of the same three embodiments of the rotor from FIG. 15.

FIG. 18 is a perspective cutaway drawing of the turbine of FIG. 12, with additional components added to allow for heat transfer to be controlled along the length of the rotor.

FIG. 19 is a perspective cutaway drawing of an embodiment of a component of the present invention, namely a regenerative expander based on the novel boundary layer turbine described by example in FIG. 12.

FIG. 20 is a perspective cross-sectional view of the same regenerative expander from FIG. 19.

FIG. 21 is a perspective cross-sectional view of an additional embodiment of the regenerative expander of FIGS. 19 and 20.

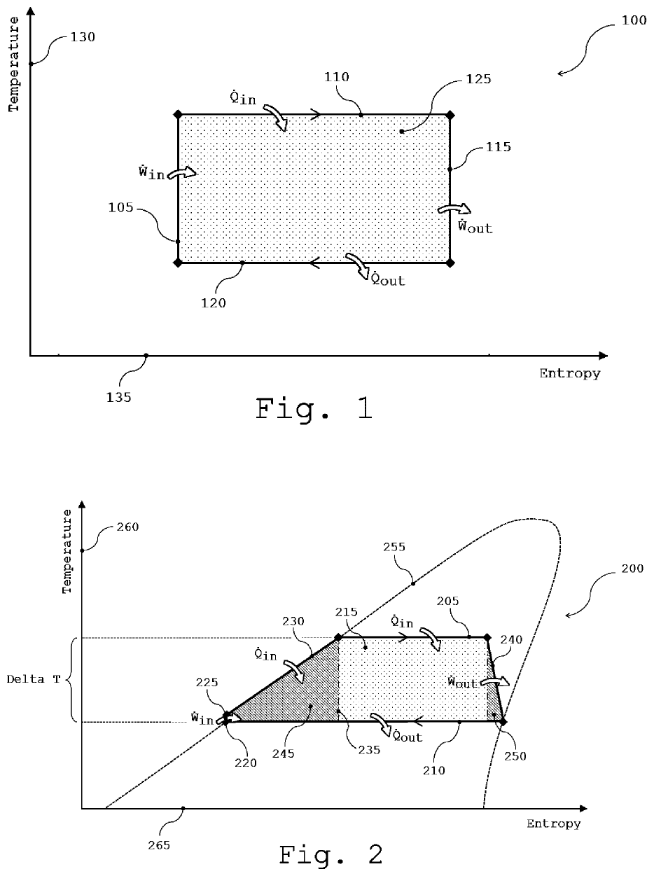

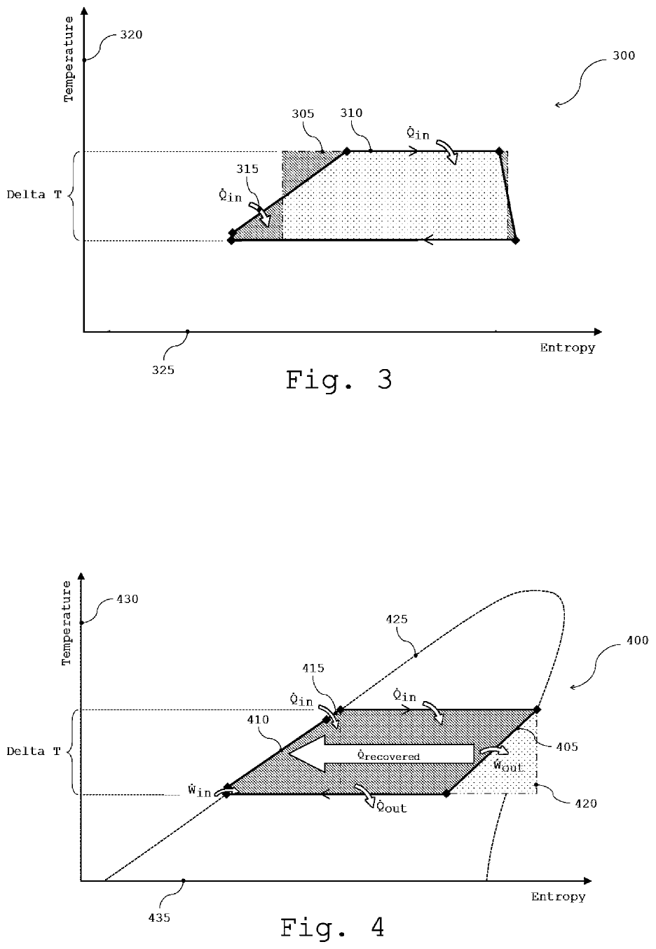

### DESCRIPTION OF EMBODIMENTS

FIG. 5 shows a high-level schematic representation of a heat engine operating using the regenerative expansion cycle, as is the case for the present invention. The schematic includes only the core functional components that are required for a heat engine to operate using this cycle. These core components are as follows: A boiler (10) in which heat is added to facilitate an isothermal expansion (evaporation) process. A condenser (11) in which heat is removed to facilitate an isothermal compression (condensation) process. A liquid pump (12) which increases the pressure of the liquid working fluid exiting the condenser (11) until it reaches a pressure at which it can enter the boiler (10). A regenerative expander (13) which comprises the following: A mechanism for concurrent, or effectively concurrent, heat and work extraction from the working fluid as it expands from the pressure at the outlet of the boiler (10) to the pressure at the inlet to the condenser (11). A mechanism for transferring the heat extracted from the working fluid during this process to the liquid working fluid between the outlet of the condenser (11) and the inlet of the boiler (10). Specific embodiments of the regenerative expander as relates to this invention are described in subsequent figures. It will be appreciated that numerous auxiliary components not shown in the included figures may be included to properly monitor and control the engine without departing from the scope of the present invention.

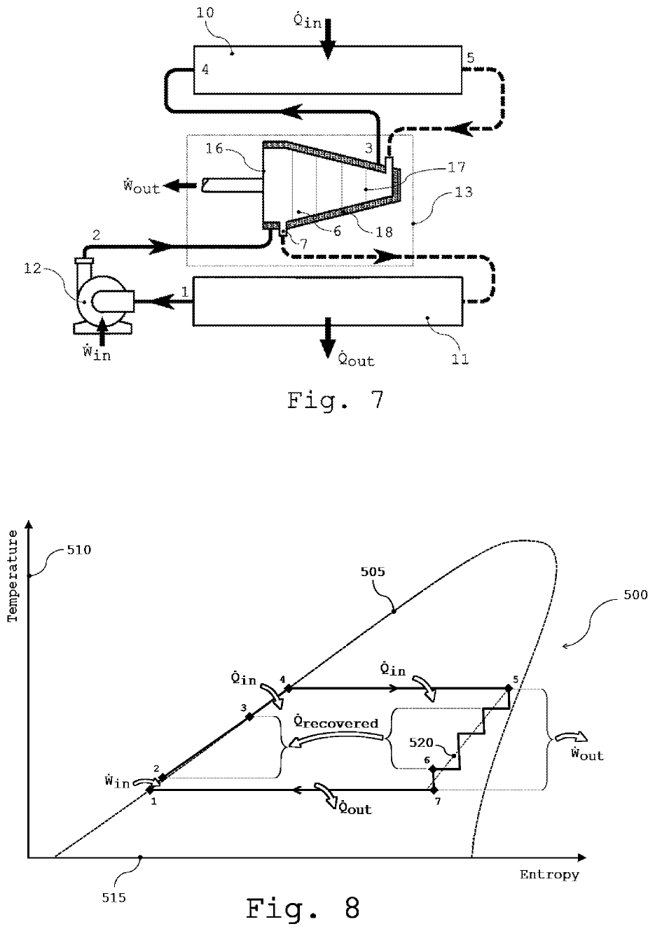

FIG. 6 is a schematic representation of an embodiment of the present invention in which the regenerative expander (13) is constructed from a series of four discrete turbines (14) interspersed with three discrete heat recovery units (15). The same core components from FIG. 5 are included, namely a boiler (10), condenser (11), and liquid pump (12), in order to complete the heat engine. In this embodiment, liquid working fluid is transferred from the liquid pump (12) through each of the heat recovery units (15) in series. It will be appreciated that the liquid side of the heat recovery units (15) may alternatively be combined into one continuous unit rather than the three discrete units shown. After evaporation in the boiler (10), working fluid is expanded through one of the turbine stages (14) before entering a heat recovery unit (15). This is repeated until the working fluid exits the last heat recovery unit (15), after which it is expanded through one final turbine stage (14) before entering the condenser (11). The flow direction of expanding working fluid through the heat recovery units (15) is counter to the direction of the liquid working fluid moving from pump to boiler. Therefore, the liquid working fluid is able to approach the temperature of the working fluid at the exit of the first turbine stage (14) before entering the boiler (10). It will be appreciated that the work output of each of the turbine stages may be combined through the use of any suitable mechanism (e.g., a common shaft, belts, gearing etc.), or utilised independently, without departing from the scope of this invention. It will also be appreciated that while the embodiment described in FIG. 6 utilises turbines (rotary expanders) as the work extraction devices, equivalent devices utilising, for example, reciprocating piston expanders could also be employed without departing from the scope of this invention.

A further embodiment of the present invention, with the same number of expansion and heat recovery stages, is described in FIG. 7. The boiler (10), condenser (11) and liquid pump (12) are retained from the system describe in FIGS. 5 and 6. However, in contrast to the multiple discrete turbines (14) and heat recovery units (15) from FIG. 6, a single pressure compounded expander (16), which includes four expansion stages (17) and a heat exchanger (18), is utilised as the regenerative expander (13). Working fluid from the liquid pump (12) is passed through the heat exchanger (18) on its way to the boiler inlet. The heat exchanger is designed in such a way as to enable the liquid working fluid to recover heat from between the expansion stages of the pressure compounded expander. The flow of the liquid working fluid through the heat exchanger (18) is generally counter to that of the flow through the expander (16) in order to allow the liquid working fluid temperature to approach that of the working fluid vapour near the expander inlet. It will be appreciated that while the pressure compounded expander shown schematically in FIG. 7 represents a rotary turbine expander, the same system can also be implemented using, for example, a pressure compounded piston expander and heat exchangers without departing from the scope of this invention.

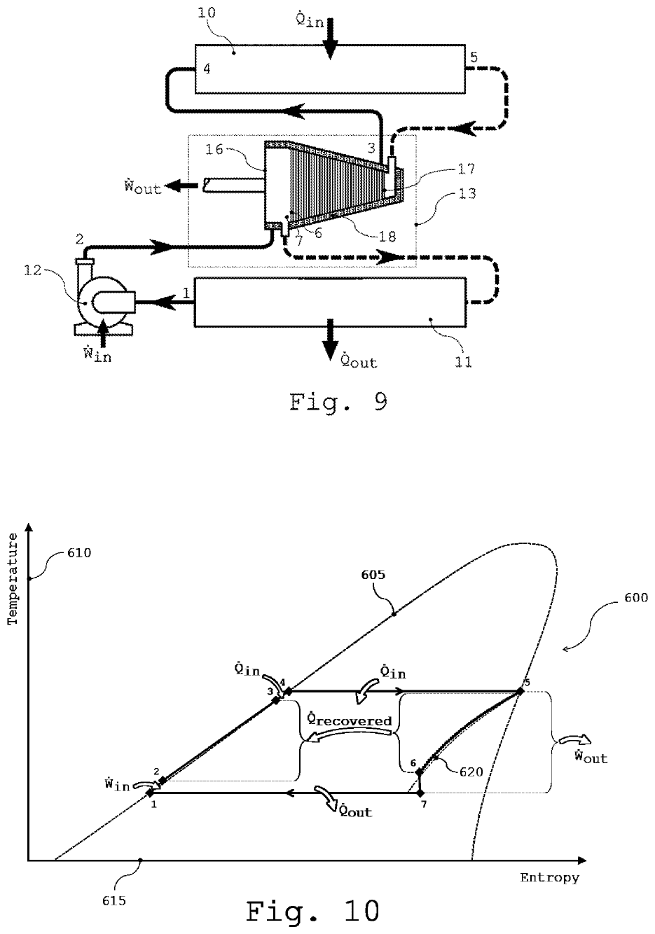

FIG. 8 is a T-s diagram (500) showing the thermodynamic cycle that would be observed for the embodiments described in both FIG. 6 and FIG. 7, assuming an equal pressure drop across each of the discrete expander stages from FIG. 6 or the internal expansion stages from FIG. 7. The points 1-7 on the T-s diagram (500) correspond to the points labelled the same in FIGS. 6 and 7. A representative working fluid saturation curve (505) is shown to indicate the state of the working fluid at each point in the cycle with respect to the temperature (510) and entropy (515) axes.

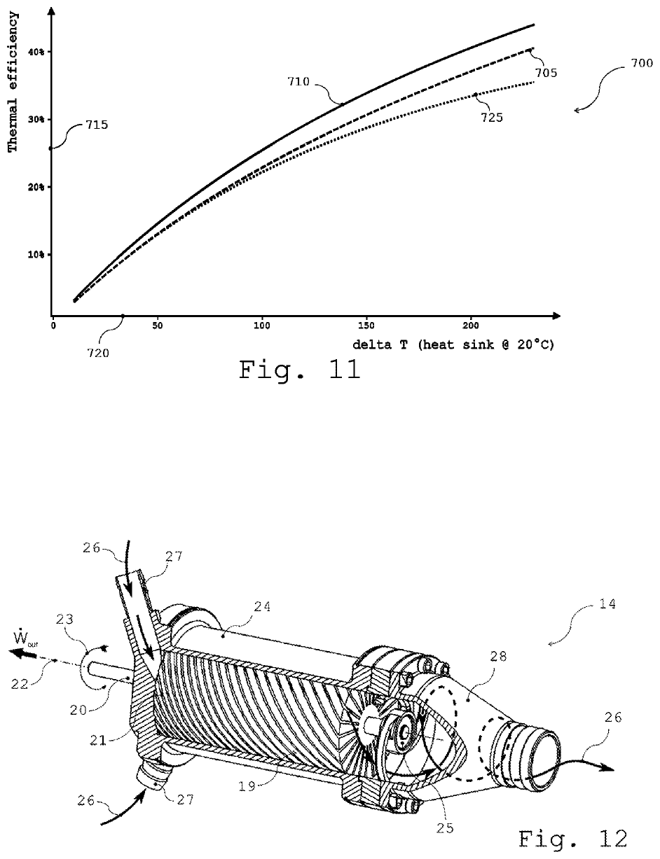

FIG. 9 describes an alternate implementation of a regenerative expansion cycle heat engine in which the heat and work extraction occur concurrently. In this implementation, the regenerative expander can be approximated by assuming it to be similar to the regenerative expander described in FIG. 7, except that the number of expansion stages (17) and associate heat recovery stages are increased to the point where the pressure drop (i.e., work extraction) and heat transfer occur near simultaneously, thereby approaching a continuous (rather than stepped) regenerative expansion process. This is shown by process 5-6 on the T-s diagram (600) for this implementation presented in FIG. 10. A representative working fluid saturation curve (605) is also shown to indicate the state of the working fluid at each point in the cycle for this implementation with respect to the temperature (610) and entropy (615) axes.

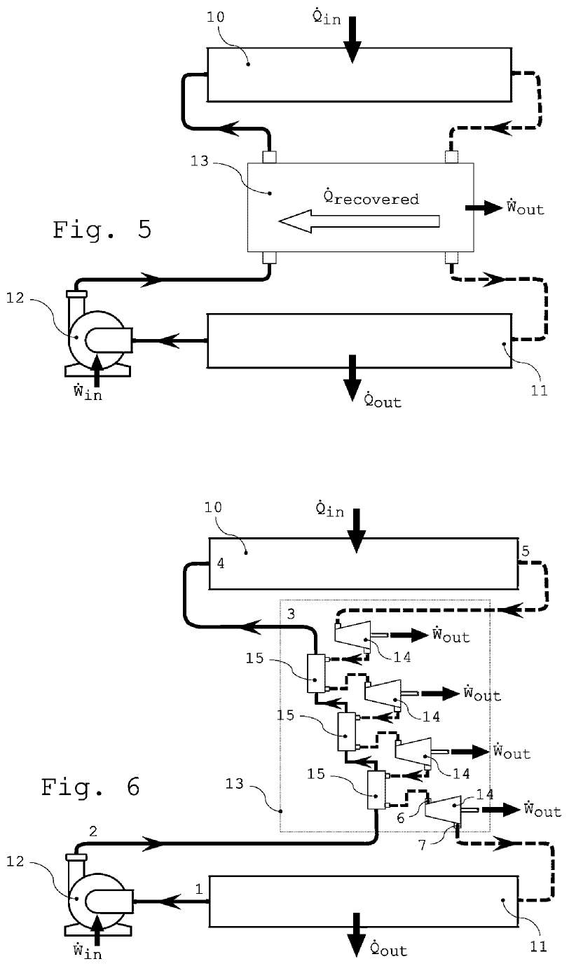

It will be appreciated that a range of turbine/expander and heat recovery stage designs may be employed (beyond those used in the embodiments described in FIGS. 6 and 7) in order to similarly approximate the ideal regenerative expansion process (405) described in FIG. 4. Therefore, any such configuration should still be considered within the scope of the present invention.

A chart (700) showing the predicted thermal efficiency (715) as a function of the temperature difference (720) between the driving thermal reservoirs for the embodiments described in FIGS. 6 and 7, using water (705) as a working fluid, is provided in FIG. 11. The chart (700) also shows the equivalent Carnot efficiency (710) for the same range of driving temperature differences as well as the predicted efficiency of a concurrent regenerative expander system (725) as described in FIGS. 9 and 10. This is provided in order to demonstrate the practical benefit of this engine. Namely its ability (with an appropriate working fluid for the required temperature range) to maintain thermal efficiencies greater than 88% of the theoretical limit (Carnot efficiency) across a wide range of driving temperature differences. This is in comparison to concurrent regenerative expander systems which show reduced performance relative to the Carnot cycle as the temperature difference increases, and even more so with respect to the thermal efficiencies closer to 50% of Carnot (or lower) which are more common for other practical heat engines.

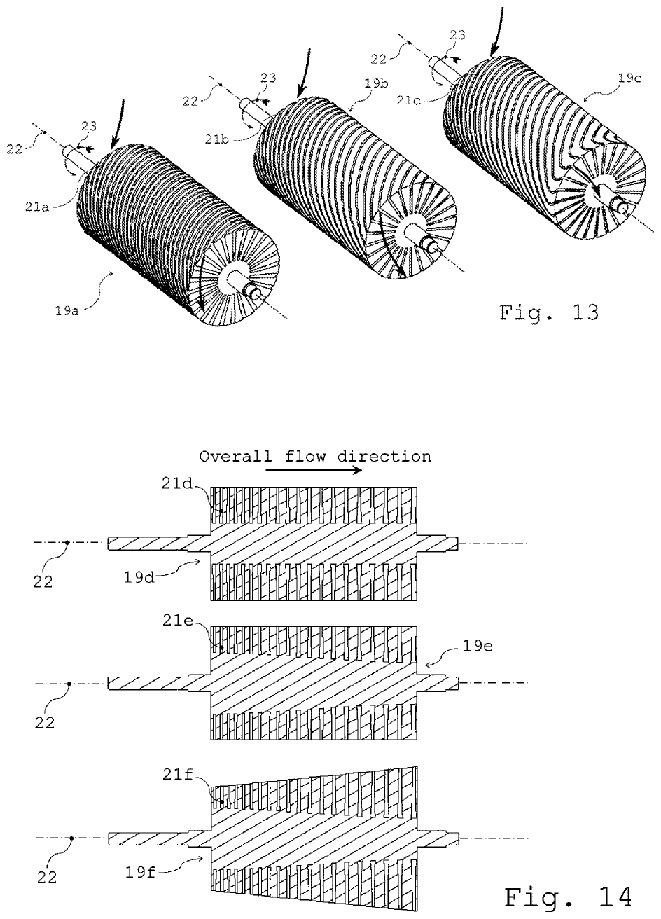

FIG. 12 shows an embodiment of a novel boundary layer turbine which may be used in an embodiment of the present invention. The turbine comprises a rotor (19) attached to a shaft (20). The rotor (19) is intersected by a plurality of narrow channels (21) which each follow a helical path along the rotational axis (22) of the rotor (19). The direction, or orientation, of the helical path is the same as the rotational direction (23) of the rotor/shaft assembly when viewed from the motive fluid inlet end. The rotor (19) is enclosed by a close-fitting casing (24) within which it is constrained in such a way as to have one degree of freedom (free rotation about the rotational axis (22)), and to prevent working fluid from escaping the confines of the system.

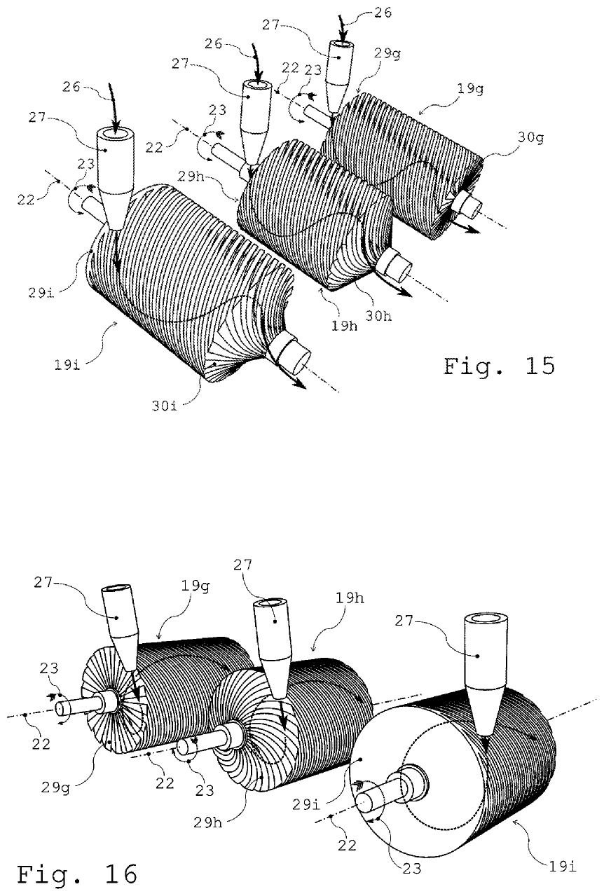

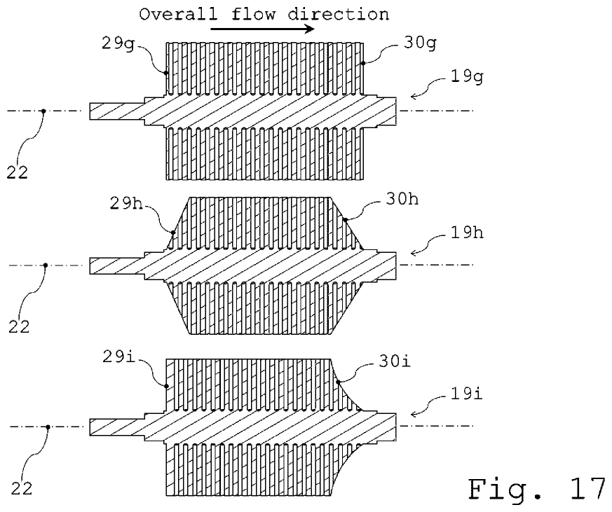

In the embodiment in FIG. 12, this constraint is achieved with simple sealed bearing assemblies (25). However, for clarity, it will be appreciated that both the method of constraint, and the means by which mechanical power is extracted from the rotor (e.g., the simple shaft (20) in the embodiments described in FIGS. 12-21) may be achieved in myriad different ways using well established mechanical principles, hence the specifics of these features are not discussed in detail here. Further, in the embodiments shown in FIG. 12 and FIGS. 18-21, the shaft (20) is shown to extend out from the motive fluid inlet side of the turbine, bridging the internal and external spaces of the turbine. It will be appreciated that in such a case, shaft sealing arrangements should be included as appropriate for the motive fluid and application under consideration. In summary, numerous alternatives to the bearing and shaft configuration shown in FIGS. 12-21 could be employed without departing from the scope of the present invention.

In the embodiment described in FIG. 12, motive fluid (26) is introduced to the rotor axially via a number of nozzles (27). The nozzles are arranged such that the motive fluid is directed towards the axial face of the rotor (19) at an angle consistent with that made by the helical path of the fluid channels (21).

The embodiment shown in FIG. 12 includes a flow guide (28) at the outlet of the turbine in order to direct the motive fluid (26) from the rotor exit towards an opening that can be conveniently connected to additional systems or components.

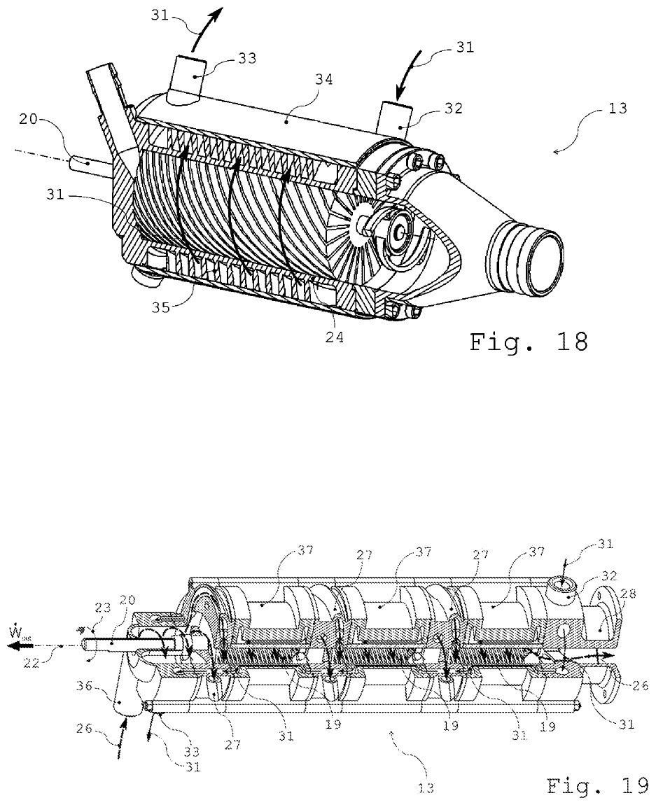

FIGS. 13-17 show a series of embodiments of the rotor of FIG. 12 and FIG. 18, and the rotors of FIGS. 19-21. These embodiments show the main ways (other than adjusting the fluid channel (21) number and spacing) in which the rotor parameters and nozzle positioning can be adjusted in order to accommodate different fluid characteristics or operating conditions, or to adjust the performance characteristics of the turbine.

FIG. 13 shows 3 embodiments (a, b and c) of the rotor (19) of FIGS. 12 and 18 in which the helical path followed by the fluid channels (21) has either a constant pitch (a) or a variable pitch (b). Further, the angle of the fluid channel as it exits the rotor may be either in line with the overall helical path (as in a and b) or it may be directed at any other angle (as in c) in order to control the outlet velocity of the motive fluid (26).

FIG. 14 shows 3 further embodiments (d, e and f) of the rotor (19) of FIGS. 12 and 18 in which the depth of the fluid channels (21) is either kept constant (d) or varied along the length of the rotor (e and f). It will be appreciated that, while the variation in depth along the length of the rotor (19) described in FIG. 14 by embodiments e and f represents a linear increase in fluid channel cross-sectional area along the overall direction of fluid flow (i.e., expansion), this variation could alternatively be non-linear and/or opposite in direction (i.e., compression) without departing from the scope of the present invention. Further, the variation in channel depth described by FIG. 14 (e) is achieved by varying the inner diameter of the helical channels only. However, this could also be achieved by varying only the outer diameter of the rotor hub, or a combination of the two (as in embodiment f).

FIGS. 15-17 show 3 embodiments (g, h and i) of the rotor (19) of FIGS. 19-21 in which the geometry of the axial faces and the position of the plurality of nozzles is different for each embodiment. In one embodiment (g), both the inlet axial face (29g) and the outlet axial face (30g) are perpendicular to the rotor axis (22) and the plurality of nozzles (27) direct the motive fluid (26) towards the inlet axial face (29g). In another embodiment (h), the plurality of nozzles (27) direct the motive fluid (26) towards the inlet axial face (29h), however both the inlet and outlet axial faces (29h and 30h) are not planar and instead form a cone symmetric about the rotor axis (22). In a further embodiment (i), the inlet axial face is closed while the outlet axial face is non-planar and forms a non-linear cone (or horn) shape. The plurality of nozzles (27) direct the motive fluid (26) towards the radial surface of the rotor (generally in line with the helical channels) rather than the inlet axial face.

It will be appreciated that while the rotor illustrated for the single stage embodiments of the turbine in FIGS. 12 and 18 and the rotors for the multi-stage embodiments of the turbine in FIGS. 19-21 are alternately used to demonstrate different rotor embodiments (a-i) in FIGS. 13-17, the features of the embodiments described by a to i in FIGS. 13-17 may be utilised in any suitable combination and for turbines of any number of stages.

FIG. 18 shows an embodiment of the boundary layer turbine described by FIG. 12. Specifically, this embodiment includes features to allow for control of heat transfer along the length of the rotor (i.e., during work extraction process). Such an embodiment of the novel boundary layer turbine may be used to implement a regenerative expander in line with the embodiment of the present invention described in FIGS. 6, 7 and 9. In this embodiment of the novel boundary layer turbine, a heat transfer fluid (HTF) is used to control the motive fluid temperature, and to transfer this heat elsewhere in the system. The HTF (31) may either be the liquid working fluid from the exit of the condenser, or an intermediate fluid, and is circulated from an inlet (32) to an outlet (33) in the outer casing (34) of the turbine. It will be appreciated that in general, the temperature of the HTF may be either higher or lower than the temperature of the motive fluid, depending on the desired direction of heat transfer. In the context of this invention however, the HTF will be at a lower temperature than the motive fluid inside the turbine. In the embodiment shown in FIG. 18, the HTF is contained between the turbine casing (24) and an external jacket (34), isolated from the motive fluid inside the turbine, and will flow in a counter current fashion to the flow direction inside the turbine. Fins/guide vanes (35) are also incorporated into the casing (24), in order to both direct the flow of the HTF and improve heat transfer rate.

The embodiment in FIG. 15 shows a counter-flow arrangement utilising a heat transfer fluid as the medium for temperature control. It will be appreciated that this function may also be achieved through alternative embodiments including HTF in parallel flow configuration, phase change heat transfer (e.g., heat pipes), ohmic heating, Peltier effect heating/cooling etc.

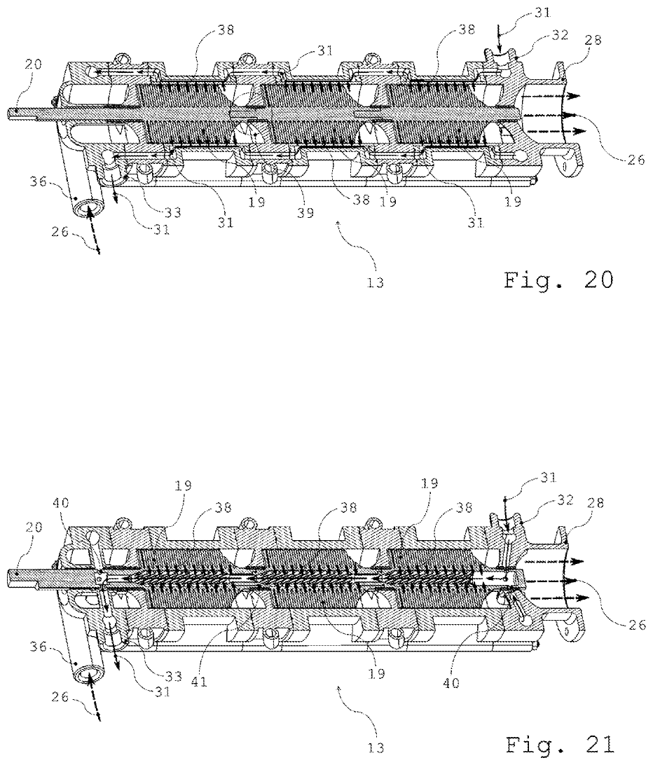

An embodiment of the regenerative expander (13) based on the novel boundary layer turbine described by example in FIGS. 12-17 is shown in FIG. 19 and FIG. 20. This embodiment has three expansion and heat recovery stages, with each stage consisting of a plurality of nozzles (27) which allow the working fluid vapour/mixture (26) to move from one stage to the next and direct it into a rotor (19) as described by example in FIGS. 12-17. Each of the rotors (19) are constrained to rotate on a common axis (22) and are mechanically connected (e.g., by keys, splines etc.) (39) such that power can be transmitted from all stages to a common output shaft (20). Each rotor stage is contained within a housing (37) which doubles as a heat exchanger through which a heat transfer fluid (31) (e.g., the liquid working fluid from the condenser) can flow. The housing assembly includes an inlet port (36) for the high-pressure working fluid vapour and an outlet port (28) for the low-pressure saturated mixture. The housing also includes an inlet port (32) and an outlet port (33) for the HTF (31) located so that flow is generally counter to the direction of motive vapour flow through the turbine, Heat transfer (38) is able to take place in the radial direction from the rotor channels to the HTF (31) flowing through the housing.

An alternative embodiment of the regenerative expander described in FIG. 19 and FIG. 20 is shown in FIG. 21. In this embodiment, rather than the HTF (31) flowing through the housing assembly, appropriately sealed ports (40) allow HTF to flow from the inlet port (32) at the low-pressure end of the turbine housing into a cavity in the centre of the rotors (19), and from this cavity to the outlet port (33) at the high-pressure end of the turbine housing. In this embodiment, this necessitates additional sealing (41) where each rotor stage connects. Further, in this embodiment, heat transfer (38) occurs radially inward (assuming the HTF is at a lower temperature than the working fluid vapour/mixture) from the helical rotor channels to the internal HTF cavity in the centre of each rotor.

It will be appreciated by those skilled in the art that numerous modifications or alternatives to the above-described embodiments may be made without departing from the essential characteristics of the present invention. Further, for the avoidance of doubt, the features described above may be utilised in any suitable combinations and features described in relation to one aspect of the invention may also be applied to another aspect of the invention, where appropriate. The embodiments and examples described above should therefore be considered in all respects as illustrative and not restrictive.

### CITATION LIST

### Patent Literature

U.S. Pat. No. 603,049 May 1913 Tesla
AU 2007356409 C1 July 2007Nica
AU 2016291301 B1 July 2016 Ford

### Non-Patent Literature

L. Talluri, P. Niknam, A. Copeta, M. Amato, P. Iora, S. Uberti, C. Invernizzi, G. Di Marcoberardino, L. Pacini, G. Manfrida & D. Fiaschi, ‘A revised Tesla Turbine concept for 2-phase applications’, E3S Web Conf., 238 (2021) 10006, DOI: https://doi.org/10.1051/e3sconf/202123810006.

1. A heat engine comprising:
i. a boiler in which heat is added to a working fluid to facilitate an isothermal (or near isothermal) expansion process;
ii. a condenser in which heat is removed from the same working fluid to facilitate an isothermal (or near isothermal) compression process;
iii. a liquid pump, connected between the condenser outlet and the boiler inlet, which increases the pressure of the liquid working fluid exiting the condenser until it reaches a pressure at which it is able to enter the boiler;
iv. a regenerative expander, connected between the boiler outlet and the condenser inlet, comprising:
a. a mechanism which extracts both work and heat from the saturated working fluid as it expands from the state at boiler outlet to the state at the condenser inlet, resulting in a net reduction in entropy of the working fluid across the regenerative expansion process;
b. a mechanism to allow said recovered heat from the regenerative expansion process to be transferred to the liquid working fluid between the condenser outlet and the boiler inlet.

2. A heat engine according to claim 1 wherein the function of the liquid pump is achieved through the use of a series of pumps, each adding a fraction of the required total pressure lift.

3. A heat engine according to any one of the preceding claims wherein the regenerative expander is comprised of one or more discrete expander-heat exchanger pairs connected in series such that:
i. heat can be extracted from the working fluid between the expander stages to achieve a stepped expansion from the boiler pressure to the condenser pressure resulting in a net reduction in entropy across the regenerative expansion process;
ii. the heat that is extracted from the working fluid between expander stages is transferred to the liquid working fluid between the condenser outlet and the boiler inlet;
iii. the work extracted from each expander can either be used independently or combined through suitable known methods.

4. A heat engine according to claim 3 wherein additional un-paired expander or heat exchanger stages are added to either or both ends of the series of expander-heat exchanger pairs.

5. A heat engine according to any of claims 3 to 4 wherein the series of discrete expander and heat exchanger stages are instead combined into a single multi-stage regenerative expander wherein expansion of the working fluid occurs in multiple steps with heat recovery in between.

6. A heat engine according to any one of claims 1 to 2 wherein the regenerative expander is comprised of a pressure compounded expander which includes a mechanism to enable heat transfer to occur concurrently with the expansion of the working fluid through the expander.

7. A turbine comprising:
i. one or more rotors, each comprising:
a. a hub, rotationally symmetrical about an axis, which is intersected by a plurality of narrow channels, each following a helical path around said axis;
b. a mechanism to extract mechanical power from said hub as it rotates;
ii. a nozzle assembly for each rotor, each comprising one or more nozzles which direct fluid towards one end of said rotor hub, at an orientation generally parallel to that formed by the path of said narrow channels;
iii. a housing, comprised or one or more parts, which forms a solid boundary around said rotor/s and includes:
a. one or more inlets;
b. one or more outlets;
c. a mechanism to constrain said rotor/s such that each has a single degree of freedom corresponding to free rotation about said axis;
d. a mechanism of isolating each rotor such that fluid must predominantly flow in series from said inlet/s, through said nozzle assembly-rotor pair/s, to said outlet/s.

8. A turbine according to claim 7, in which the cross-sectional area of said narrow channels at any given point is defined by any function of the position of said point along the length of said narrow channels, including any function that would result in a constant channel cross-sectional area.

9. A turbine according to any of claims 7 to 8, in which the pitch of the helical paths followed by said narrow channels at any given point is defined by any function of the position of said point along the length of said rotor hub, including any function that would result in a constant pitch.

10. A turbine according to any of claims 7 to 9, in which the paths followed bay said narrow channels are modified such that the exit length deviates from the primary helical curve in such a way as to align with any angle other than the one that would be made by the primary helical curve as it exits said rotor hub.

11. A turbine according to any of claims 7 to 10, the housing of which further comprises a mechanism via which heat can be transferred through the solid boundary of the housing to a separate medium.

12. A turbine according to any of claims 7 to 11, further comprising a mechanism to transfer heat from the core of said rotor/s to a separate medium.

13. A fluid pump comprising:
i. one or more rotors, each comprised of:
a. a hub, rotationally symmetrical about an axis, which is intersected by a plurality of narrow channels, each following a helical path around said axis;
b. a mechanism to impart mechanical power to the hub and cause it to rotate about said axis;
ii. a housing, comprised of one or more parts, which forms a solid boundary around said rotor/s and includes:
a. one or more inlets;
b. one or more outlets;
c. a mechanism to constrain said rotor such that it has a single degree of freedom corresponding to free rotation about said axis;
d. a mechanism to allow fluid to flow in series from said inlet/s, through said helical channels in said rotor/s, to said outlet/s.

14. A fluid pump according to claim 13, in which the cross-sectional area of said narrow channels at any given point is defined by any function of the position of said point along the length of said narrow channels, including any function that would result in a constant channel cross-sectional area.

15. A fluid pump according to any one of claims 13 to 14, in which the pitch of the helical paths followed by said narrow channels at any given point is defined by any function of the position of said point along the length of said rotor hub, including any function that would result in a constant pitch.

16. A fluid pump according to any one of claims 13 to 15, in which the paths followed bay said narrow channels are modified such that the exit length deviates from the primary helical curve in such a way as to align with any angle other than the one that would be made by the primary helical curve as it exits said rotor hub.

17. A heat engine according to any of claims 3 to 5 wherein said expanders are as recited in any of claims 7 to 10.

18. A heat engine according to any of claims 1 to 2, wherein the regenerative expander comprises:
i. a turbine as recited in any of claims 11 to 12;
ii. a mechanism via which the heat recovered from said turbine can be transferred to the liquid working fluid between the condenser outlet and the boiler inlet.

19. A heat engine according to any one of claims 1 to 6 or any one of claims 17 to 18, wherein the liquid pump (or pumps) is as recited in any one of claims 13 to 16.
